(19) United States
(12) Patent Application Publication
(10) Pub. No.: US 2014/0048648 A1
(43) Pub. Date: Feb. 20, 2014

(54) Free Spinning Wheel for Airplanes

(71) Applicant: Winter Karl, Houston, TX (US)

(72) Inventor: Winter Karl, Houston, TX (US)

(21) Appl. No.: 13/588,822

(22) Filed: Aug. 17, 2012

(51) Int. Cl. B64C 25/40

(52) U.S. Cl. CPC B64C 25/40
USPC 244/103 S

(57) ABSTRACT

The landing gear wheels of an aircraft include modified tires mounted on the rim of the wheel include a plurality of fins integral with the sidewall of the tires and configured to catch the wind created by movement of the aircraft through the air for spinning the wheel in a forward motion direction when the landing gear has been deployed and before the aircraft touches down, thereby reducing the friction between the runway and the tire upon touchdown.

### BACKGROUND OF THE INVENTION

1. Field of the Invention

The invention is generally related to a free spinning wheel for vehicles and the like and is specifically directed to a free spinning wheel for aircraft landing gear.

2. Discussion of the Prior Art

Conventional airplanes include landing gear with wheels which are not driven but spin when in contact with the runway as the plane lands or takes off. During landing, the stationary tire engages the runway with substantial impact causing the wheel to turn. The impact and friction between the wheel and the runway causes substantial forces to be absorbed by the wheel, often causing skidding and loss of rubber, as well as generating heat and in some cases generating smoke, all due to the shock of landing. Repeated landings cause damage to wheel, reducing its useful life.

Over the years a number of solutions involving pre-spinning of the landing wheels have been developed. The intent of these inventions is to bring the landing wheel into a spinning action before it touches the runway, reducing friction and wear and tear on the wheel.

Examples of such systems include:

U.S. Pat. No. 4,061,294 issued to Hawkins on Dec. 6, 1977. The Hawkins patent discloses an aircraft wheel rotator comprising plow like deflectors and fan like spokes on the wheels. The plow like deflectors cause air to be funneled downwardly and rearwardly to impinge on the fan like wheel spokes for spinning the wheels prior to contact with the runway.

U.S. Pat. No. 5,165,524 issued to Lewis, et al, on Nov. 24, 1992. The Lewis patent discloses a powered control system for rotating the wheels prior to contact with the ground. This system includes an impeller disc mounted on the rim of the wheel and a housing attached in a non-rotating manner in communication with the impeller disc. A pressure source is connected to one side of the housing and a vacuum is attached to the opposite side. A control system manages the amount of air entering the housing for spinning the wheel at various RPMs.

U.S. Pat. No. 6,032,900 issued to Smith on Mar. 7, 2000. The Smith patent discloses an annular plate attached to the wheel and including a plurality of air scoops arranged in a manner for capturing oncoming wind to effect rotation of the wheel.

U.S. Pat. No. 6,450,448 issued to Suzuki on Sep. 17, 2000. The Suzuki patent discloses a pneumatic drive unit for controlling the speed of the wheel of an airplane prior to landing and during takeoff.

U.S. Published Application No. US 2009/0182462, dated Jul. 16, 2009, publishing application Ser. No. 12/008,666 by Schmitz. The Schmitz publication discloses a wheel spinning device utilizing power generated by the plane jet engine to rotate the wheel before it touches the ground.

All of these systems have one feature in common in that each requires modification of the landing gear system and the addition of components to the landing gear, wheel assembly and/or aircraft in order to accomplish the objective of spinning the landing gear wheels prior to touchdown. This requires substantial cost to install, increased weight of the aircraft, and high maintenance.

### SUMMARY OF THE INVENTION

The subject invention is directed to apparatus for spinning the landing gear wheels of an aircraft prior to touchdown with modification of the aircraft, wheel assembly and landing gear. Further, no power is required in order to accomplish the spinning action. This is accomplished by modifying the replaceable tire to be installed on a standard aircraft landing gear wheel rim.

The tire includes a series of integral fins or scoops on the side wall thereof for catching the natural flow of air as the aircraft moves through the air, causing a natural spin of the wheels whenever the landing gear is deployed. The fins or scoops may be on the outer side wall or the inner side wall as a matter of choice. The spin is sufficient to reduce the friction and minimize the wear and tear on the tire when the aircraft touches down and the wheels engage the runway.

In the described embodiment the fins or scoops are located on the outer facing sidewall of the tire and are radially spaced about the circumference. The fins or scoops are configured to cause the wheels to rotate in the desired direction during landing. This reduces wear and tear on the tire without requiring any modification of any component of the aircraft other than the replaceable tire. It also accomplishes this objective with a minimum of weight being added to the aircraft structure.

### BRIEF DESCRIPTION OF THE DRAWINGS

FIG. 1 shows a perspective view of a landing gear wheel with a tire mounted on the rim having fins or scoops integral therewith for rotating the wheel and tire by the natural flow of air as the aircraft moves through the air.

FIG. 2 is similar to FIG. 1, showing an alternate configuration for the fins or scoops.

FIG. 3 is similar to FIG. 1, showing an alternate configuration for the fins or scoops.

FIG. 4 is a side vies of a landing gear wheel with a tire mounted on the rim, with another alternate configuration for the fins or scoops.

### DETAILED DESCRIPTION

Specifically, the invention is directed to a modified tire for a landing gear wheel of an aircraft, the tire being adapted to be mounted on the wheel and being adapted to promote spinning of the wheel in a controlled direction when the landing gear has been deployed and before the aircraft touches down for spinning the wheel in the direction of forward motion, thereby reducing the friction between the runway and the tire upon touchdown, the modified tire comprising. A plurality of scoops or fins are integral with the sidewall of the tire and configured to catch the wind created by movement of the aircraft through the air for spinning the wheel in a forward motion direction. The fins or scoops may be on the outer side wall or the inner side wall as a matter of choice.

It is an important feature of the invention that the wheels on the landing gear of an aircraft can be brought to a suitable spin velocity before the aircraft touches down on the runway. This reduces friction between the landing gear tires and minimizes wear and tear, potentially extending the life of the tires.

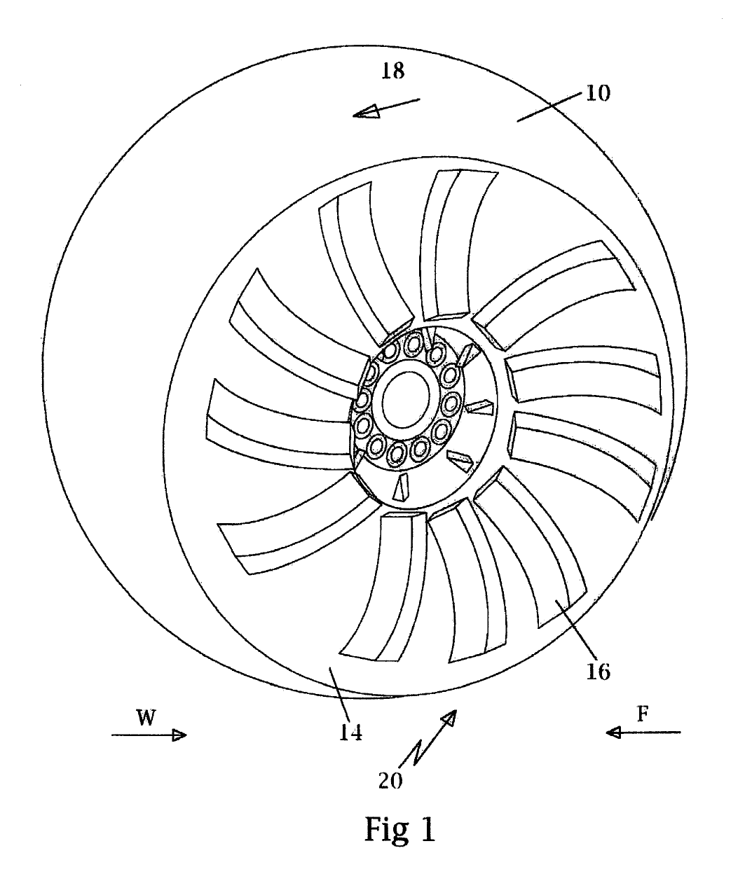

A first configuration of the invention is shown in FIG. 1. As there shown, a landing gear tire 10 is mounted on a typical landing gear wheel rim 12. The sidewall 14 of the tire includes a plurality of fins or scoops 16 radially positioned about the periphery of the tire. The fins or scoops of this embodiment are crescent shaped for spinning the wheel in a counterclockwise direction as indicated by arrow 18 when the wind is in the direction of arrow W, or when the aircraft is flying in the direction of arrow F. The crescent shape catches the flowing air at the bottom 20 of the wheel and causes it to spin in the desired direction.

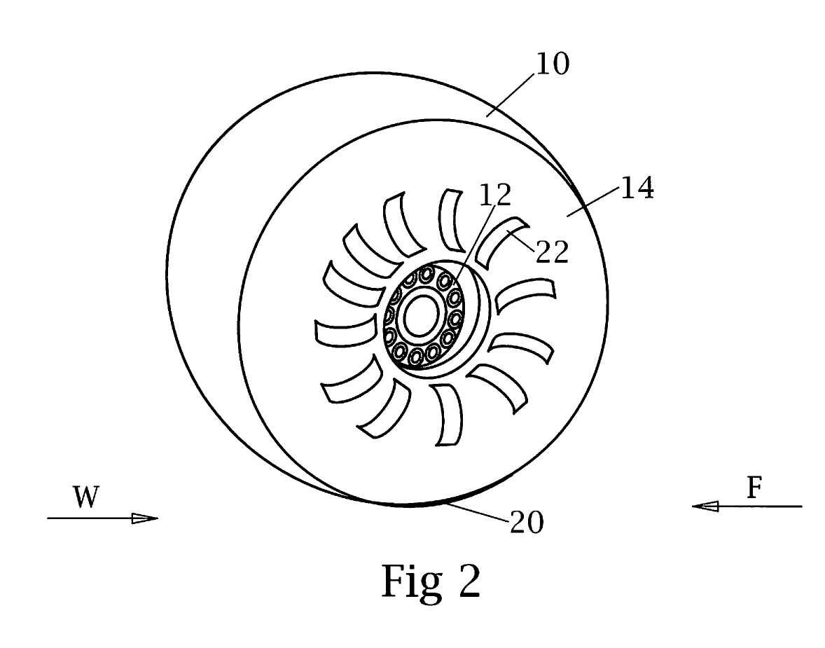

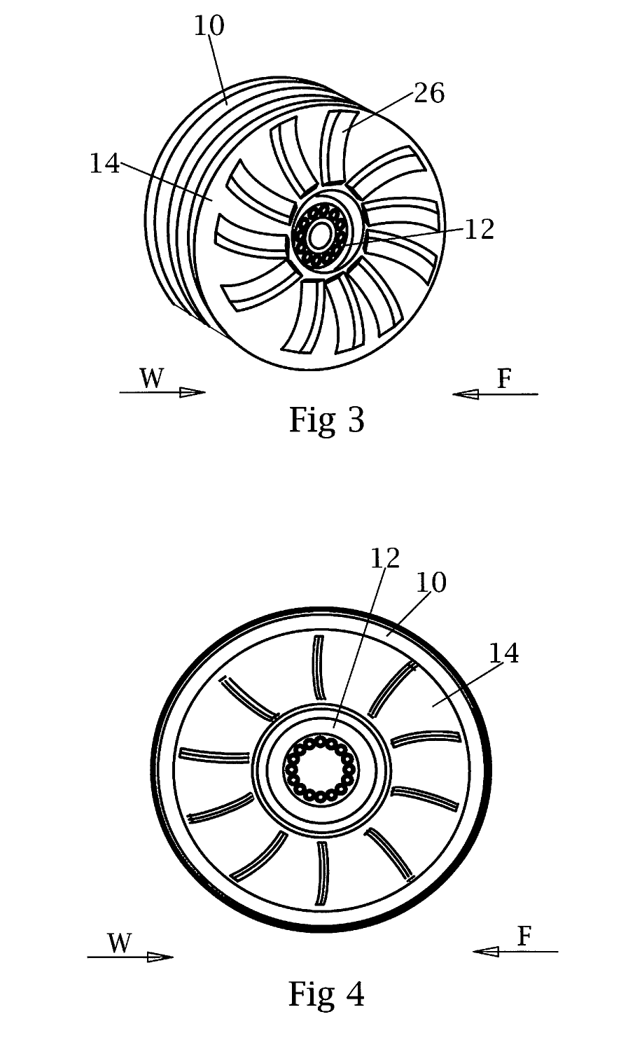

An alternative embodiment is shown in FIG. 2, wherein the fins or scoops 22 are closer to the rim or hub of the wheel. The size and shape of the fins or scoops control the speed of the spin. Alternative embodiments of the fins or scoops 26 and 28 are shown in FIGS. 3 and 4, respectively. Other configurations for the fins or scoops can be utilized depending on clearance issues, speed of rotation and similar factors without departing from the scope and spirit of the invention.

While certain features and embodiments of the invention have been described herein, it should be understood that the invention all modifications and enhancements within the scope and spirit of the following claims.

1. A device for spinning a landing gear wheel of an aircraft once the landing gear has been deployed and before the aircraft touches down on a runway, the device comprising:
a. A tire mounted on the wheel, the tire having a sidewall;
b. A plurality of fins integral with the sidewall of the tire and configured to catch the wind created by movement of the aircraft through the air for spinning the wheel in a forward motion direction.

2. The device of claim 1, wherein the fins are crescent shaped to control the direction of rotation of the wheel.

3. The device of claim 1, wherein the length of the fins are sized to control the speed of rotation of the wheel relative to air speed.

4. The device of claim 1, wherein the fins are on the interior sidewall of the tire.

5. The device of claim 1, wherein the fins are on the outer sidewall of the tire.

6. The device of claim 1, wherein the fins are on both the inner and the outer sidewalls of the tire.

7. A modified tire for a landing gear wheel of an aircraft, the tire adapted to be mounted on the wheel and adapted to promote spinning of the wheel in a controlled direction when the landing gear has been deployed and before the aircraft touches down for spinning the wheel in the direction of forward motion, thereby reducing the friction between the runway and the tire upon touchdown, the modified tire comprising:
a. A tire mounted on the wheel, the tire having a sidewall;
b. A plurality of fins integral with the sidewall of the tire and configured to catch the wind created by movement of the aircraft through the air for spinning the wheel in a forward motion direction.

8. The device of claim 4, wherein the fins are crescent shaped to control the direction of rotation of the wheel.

9. The device of claim 1, wherein the length of the fins are sized to control the speed of rotation of the wheel relative to air speed.

10. The device of claim 1, wherein the fins are on the interior sidewall of the tire.

11. The device of claim 1, wherein the fins are on the outer sidewall of the tire.

12. The device of claim 1, wherein the fins are on both the inner and the outer sidewalls of the tire.
